(19) United States
(12) Patent Application Publication
(10) Pub. No.: US 2002/0153075 A1
(43) Pub. Date: Oct. 24, 2002

(54) Shock absorber wheel for vehicles

(76) Inventor: Willard H. Schmidt, Albuquerque, MN (US)

Correspondence Address: Willard H. Schmidt, 2015 Altz NE, Albuquerque, NM, 87112, US

(21) Appl. No.: 09/839,867

(22) Filed: Apr. 23, 2001

(51) Int. Cl. B60B 9/10

(52) U.S. Cl. 152/46

(57) ABSTRACT

A land vehicle wheel in which the inner annular pneumatic shock absorber element 3 is located within the wheel itself, and not in contact with the roadbed, as is the case with the pneumatic tire in prior art. The inner annular pneumatic shock absorber element is made of flexible resilient material and is fitted within the wheel between two annular rims with facing concave surfaces 2,4. Air tight pressure seals are made between the inner annular pneumatic shock absorber element 3 and the inner annular rim 4. The interacting force between the two annular rims 2,4, due to the pneumatic pressure in the annular shock absorber element, creates a strong and stable link between these rims. The friction tread 1, in contact with the roadbed, is located on the periphery of the outer annular rim 2. The tread may be made from a resilient solid rubber or plastic compound with grooves cut into it, or designs molded into it. The inner annular rim 4 is rigidly connected to the wheel support and mounting section 5, which fits over the vehicle axle hub 6.

### BACKGROUND—FIELD OF THE INVENTION

This invention relates to wheels for all types of vehicles which make contact with a roadbed or runway.

### BACKGROUND—DESCRIPTION OF PRIOR ART

The wheels on most automobiles, trucks, aircraft, etc. commonly have a shock absorber element on the periphery of the wheel, and it is known as a tire. In the early days, the tire was solid and made of a hard rubber compound. Later, the tire was made of a rubber casing, inside of which was a rubber inner tube that was inflated with air pressure to provide a shock-absorbing cushion. It was mounted on a rim located on the periphery of the wheel. At one time, leather straps were made and fitted over the periphery of the tire to provide protection for the tire and minimize road wear to the tire tread and the tire casing. In later years the tire inner tube was eliminated, and the tire casing was designed to provide an airtight seal with the body of the wheel. Also, a tire tread consisting of a thick layer of rubber compound was vulcanized or sealed to the periphery of the tire casing to enhance the wear characteristics of the tire.

Present day vehicle tires, located on the periphery of the wheels, are pneumatic and filled with air under pressure. They constitute a significant safety hazard. They are vulnerable to wear and to road hazards which can cause a rapid decompression, or “blowout”, that can result in loss of control of the vehicle. This has lead to injury and death of the occupants of vehicles. There have been many manufacturer recalls of both tires and vehicles because of problems with vehicle tire safety.

### OBJECTS AND ADVANTAGES

The advantages of the Shock Absorber Wheel for Vehicles described in this patent are:

(a) to provide a wheel for a vehicle in which the major shock absorbing element is within the wheel itself, and not on the periphery of the wheel where it would be in contact with the roadbed and vulnerable to road wear and road obstructions, which in the past have resulted in major safety problems with tires on automobiles, trucks, and aircraft.

(b) to provide a vehicle wheel for which the solid rubber compound tread, located on the periphery of the wheel in contact with the road-bed, is not in direct contact with the inner annular pneumatic shock absorber element of the wheel, and, therefor, any damage to the tread, or tread wear, cannot effect the performance of the inner annular pneumatic shock absorber element.

(c) to provide a vehicle wheel with an inner annular pneumatic shock absorber element, located within the wheel itself and away from the periphery of the wheel, for which the risk of a “blowout”, or rapid loss of air pressure, is made insignificant.

(d) to provide a vehicle wheel for which the shock absorbing ability is greater than that for the conventional prior art wheel with a peripheral pneumatic tire, because the direction of the shock absorber action for the subject patent wheel, with an inner annular pneumatic shock absorber element, is reversed from that of the conventional peripheral tire.

(e) to provide a vehicle wheel construction which is more versatile, less expensive, and safer to use than that of prior art.

(f) to provide an inner annular pneumatic shock absorber element for a vehicle wheel which is integral in itself and does not have, or depend on, a peripheral tread that is vulcanized or cemented to it, as does prior art.

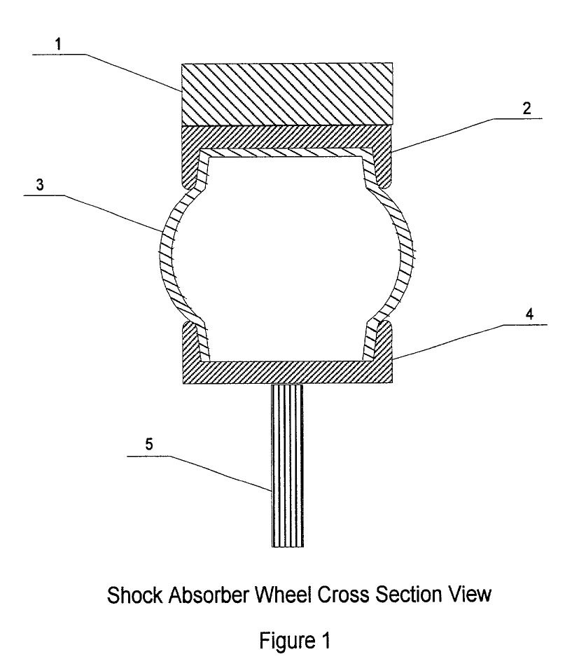

### DRAWING FIG. 1

The FIG. 1 drawing is a cross sectional view of the wheel from the center region of the wheel to the outer periphery.

### Reference Numerals in Drawing

1. tread

2. outer annular rim

3. inner annular pneumatic shock absorber element

4. inner annular rim

5. wheel support and mounting section

### Description of FIG. 1

Starting from the outer periphery of the wheel is the solid rubber composition tread 1. The outer surface of the tread has suitable groves cut or molded into it to provide traction with the roadbed as the wheel turns.

The tread 1 is bonded, cemented, or mechanically attached to the periphery of the annular shaped outer annular rim 2. The inner surface of the outer annular rim 2 is concave to permit the inner annular pneumatic shock absorber element 3 to fit into it.

The inner annular pneumatic shock absorber element 3 fits in between the outer annular rim 2 and the inner annular rim 4. The inner annular pneumatic shock absorber element 3 has an annular shape that is closed at the outer surface and open along the inner side, and consequently, the two adjacent sides of this shock absorber element can move under pneumatic pressure to form air tight seals with the corresponding surfaces of the concave side of the inner annular rim 4.

The inner annular rim 4 is annular in shape with a concave outer surface to accommodate the inner annular pneumatic shock absorber element 3 when it is pressurized. The inner surface of the inner rim 4 is supported on the inner surface (facing the center of the wheel) by virtue of its rigid attachment to the wheel support and mounting section 5.

The wheel support and mounting section 5 is the rigid metal structural and mounting section in the central region of the wheel that is rigidly attached to the inner surface of the inner annular rim 4.

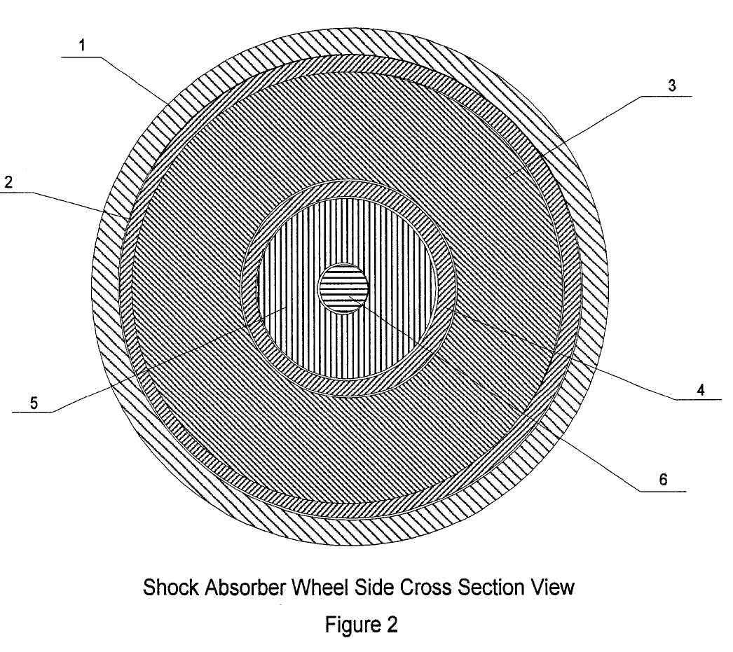

### Drawing FIG. 2

The FIG. 2 drawing is a side cross sectional view of the Shock Absorber Wheel for Vehicles.

### Reference Numberals in Drawing

The reference numerals for FIG. 2 are the same as for FIG. 1. However, the axle hub 6 is shown for clarity.

### Description of FIG. 2

FIG. 2 illustrates the positions of the various components of the Shock Absorber Wheel in a side cross sectional view.

The solid rubber composition tread 1, located on the outer periphery of the wheel is bonded, cemented, or mechanically attached to the outer annular rim 2.

The inner annular pneumatic shock absorber element 3, is located between the outer annular rim 2 and the inner annular rim 4, and fits snugly inside of the respective concave surfaces of these two annular rims.

The outer annular rim 2 and the inner annular rim 3 are both located within the wheel, and they each have a concave surface that faces the opposing annular rim. The inside concave surface of the outer annular rim 2 faces the outer concave surface of the inside annular rim 4.

The wheel support and mounting section 5 is located near the central region of the wheel and is rigidly connected to the inner annular rim 4.

The hub 6 at the center of the wheel is part of the axle assembly, and it is shown here for orientation and clarity.

### Operation

The wheel for this patent operates in a manner similar to that for state of the art vehicle wheels in that it rotates on an axle secured to the vehicle, and the tread on the outer periphery is in contact with the roadbed. The wheel for this patent differs from prior art vehicle wheels that have the pneumatic tire, or shock absorbing element, in contact with the roadbed, because in this subject patent wheel the inner annular pneumatic shock absorber element 3 is located within the wheel itself and away from the periphery of the wheel. Therein lies a major safety advantage because the inner annular pneumatic shock absorber element 3, which contains air pressure, is not vulnerable to road wear and road hazards that could otherwise result in deflation, or “blowout”, which may result in personal injury and property damage.

The solid rubber compound tread 1 on the periphery of the wheel is in contact with the roadbed. The surface of the tread can have grooves cut into it or certain designs molded into it to increase the frictional contact with the roadbed. The tread is secured to the outer annular rim 2 by vulcanizing, cementing, or by mechanical means.

The vehicle is cushioned from road shock by means of the inner annular pneumatic shock absorber element 3 within the wheel and located between the inner 4 and outer 2 annular rims. This inner annular pneumatic shock absorber element fits snugly into the inner concave surface of the outer annular rim 2, and the two sides of this shock absorber element make air tight seals with the corresponding surfaces of the concave outer surface of the inner annular rim 4. Roadbed shock to the wheel is attenuated by this inner annular pneumatic shock-absorbing element. Unlike conventional prior art vehicle wheels, the road shock progresses from the wheel support and mounting section 5, located in the central region of this patent wheel, outward to the inner annular pneumatic shock absorber element, rather than inward from the roadbed directly to the pneumatic tire, as in prior art vehicle wheels. Consequently, there is a major safety advantage for this patent wheel.

The inner annular rim 4 is in solid contact with the wheel support and mounting section 5 that is securely mounted to the drum that surrounds the hub 6 and the axle assembly for the vehicle.

### Summary, Ramifications, and Scope

This subject patent wheel constitutes the latest major advance in the development of a wheel for use on land transportation vehicles. It follows earlier developments, which eliminated the use of rubber tubes inside of vehicle tire casings. Previous art is surpassed in this patent wheel by removing the pneumatic element (the tire) from the periphery of the wheel, where it is in contact with the roadbed, to a location inside of the wheel itself. The inner annular pneumatic shock absorber element in this patent wheel provides enhanced shock absorbing action, and the shock forces due to the roadbed are directed to the inner annular pneumatic shock absorber element from the central region of the wheel outward, rather than from the periphery of the wheel inward as in prior art. The result is a significant increase in safety to vehicle passengers over prior art which have had tire “blowout” problems, that have caused many deaths and injuries.

This wheel patent provides a vehicle wheel which will withstand much more severe road bed shock conditions than any prior art because of the manner in which the shock forces are distributed, and in the manner in which the inner annular pneumatic shock absorber element is protected by the solid rubber compound tread on the periphery of the wheel. Consequently, this patent wheel is of great value for all land vehicle wheels and especially for aircraft wheels where enormous shock forces are encountered on landing. Plane crashes due to tire “blowout” can be dramatically reduced with this patent wheel because the inner annular pneumatic shock absorber element is not in contact with the runway, or with obstacles that may lie on the runway and cause damage to the wheel.

This patent wheel is an advancement in the state of the art of land vehicle wheel development. For particular applications, the wheel component called the inner annular shock absorber may be a solid material shock absorber element, which may be made of a resilient solid rubber compound. The solid material can provide more shock resistant durability than a pneumatic element, but for long term continuous applications the solid material shock absorber will generate more internal frictional heat. Consequently, the pneumatic element is to be preferred for most continuous operation applications.

The solid rubber compound tread secured to the outer annular rim of the wheel is in contact with the roadbed. The selected type of tread is cut or molded into the hard rubber compound. One type of tread may be exchanged for another type by simply using a different tread and outer annular rim assembly. Therefore, for example, changing from a summer tread to a winter snow tread is a simple and inexpensive matter.

The entire subject patent wheel assembly is made for safe and long lasting use. The simple construction is cost effective, and should make vehicle operation less expensive and a great deal safer than prior art.

I claim:

1. An annular pneumatic shock absorber element located within the body of a vehicle wheel and between two concentric annular rims.

2. Two concentric annular rims of claim 1 located within the body of the wheel.

3. Each of the two concentric annular rims of claim 1 has a concave surface: the concave surface of the outer rim faces inward toward the inner rim, and the concave surface of the inner ring faces outward toward the outer rim.

4. The respective concave surfaces of the two concentric annular rims of claim 1 are shaped to accommodate the annular pneumatic shock absorber element located between them, and to provide surfaces against which the pressurized annular pneumatic shock absorber element can fit tightly and form airtight seals.

5. Said annular pneumatic shock absorber element of claim 1 can be made of a flexible resilient material such as a rubber compound or plastic material.

6. Said pneumatic shock absorber element of claim 1 consists of an integral annular unit that is open along the inner side to allow the two adjacent sides of the element to move outward under pneumatic pressure, and form air tight seals against the corresponding surfaces of the concave inner annular rim.

7. Said annular pneumatic shock absorber element of claim 1, due to the pneumatic pressure within it, creates an interacting force between and against the inner and outer concentric annular rims to form a strong and stable link between these rims.

8. Said annular pneumatic shock absorber element of claim 1 provides a shock-absorbing cushion within the body of the wheel between the roadbed and the central region of the wheel.

9. Said annular shock absorber element of claim 1 may consist of a solid rubber or plastic compound of toroidal shape that fits between the outer and inner annular rims.

10. Said outer annular rim of claim 1 has a solid resilient material attached to the outer peripheral surface, and this is the tread layer that provides frictional contact between the wheel and the roadbed.
